(19) United States
(12) Patent Application Publication
(10) Pub. No.: US 2020/0007634 A1
(43) Pub. Date: Jan. 2, 2020

(54) CROSS-ONLINE VERTICAL ENTITY RECOMMENDATIONS

(71) Applicant: Microsoft Technology Licensing, LLC, Redmond, WA (US)

(72) Inventors: Wanyan Xie, San Jose, CA (US); Shen Huang, San Jose, CA (US); Xiaonan Duan, Mountain View, CA (US); Viktoras Truchanovicius, Santa Clara, CA (US); Suhai Liu, Palo Alto, CA (US)

(21) Appl. No.: 16/023,230

(22) Filed: Jun. 29, 2018

(51) Int. Cl. H04L 29/08; G06Q 30/02; G06F 17/30; G06F 17/16; G06K 9/62

(52) U.S. Cl. CPC H04L 67/22; G06Q 30/0282; H04L 67/306; G06F 17/16; G06K 9/6215; G06F 17/30616

(57) ABSTRACT

A historical online user behavior-based approach is used to make a recommendation of a cross-online service vertical entity for a primary online service vertical entity with which a user is currently interacting online. The recommendation is made based on the similarity of historical online user behavior between the vertical entities. To do this, historical online user behavior of each of the vertical entities is represented as a respective vector. Each dimension of a vector represents a historical level of interaction between a separate user or a separate group of related users and the vertical entity represented by the vector. A similarity measure is used to measure the similarity between the vectors for the vertical entities. The recommendation of the cross-online service vertical entity is then made for the primary online service vertical entity based on the extent of the similarity between the vectors according to a similarity measure.

### TECHNICAL FIELD

The present disclosure is directed to in general to computer-implemented techniques and graphical user interfaces for online recommendations to users of online services, and, more particularly, to computer-implemented techniques and graphical user interfaces for online recommendations of cross-online service vertical entities based on similar historical online user behavior between the entities.

### BACKGROUND OF THE DISCLOSURE

Today, many online services are cross-vertical. That is, they make content across multiple online service verticals available over a data network (e.g., the internet) to users of the online service via a computer user interface (e.g., a graphical user interface). As just one of many possible examples, some online professional networks provide both online employment seeking and online learning. In this example, employment seeking is one online service vertical available to users of the online service and online learning is another online service vertical available to users. There are many other examples of online service verticals where the primary information and media available to users is specific to a particular industry or market or other group of users with specific needs.

Typical approaches for online service recommendations make like for like recommendations. That is, the recommendations are for the same type of online service vertical entity that a user is currently interacting with online. For example, while a user is taking a particular online learning course, a typical approach might recommend another related online learning course to the user. For example, after a user completes an online learning course on introduction to machine learning, the user may receive a recommendation for a more advanced machine learning course. As another example in a different vertical, a user that is viewing a particular employment opportunity posting may receive a recommendation for other employment opportunities requiring the same or similar qualifications.

There are online services that provide cross-vertical recommendations. For example, the online service known as LinkedIn™ of Mountain View, Calif. provides cross-vertical recommendations. For example, while a user is viewing their member profile on the professional network they may receive a recommendation to apply for a particular employment opportunity. The recommendation may be presented on the user's member profile web page, for example. In this example, the professional network is one online service vertical available to users of the LinkedIn™ online service and employment seeking is another online service vertical available to users.

Typical approaches for cross-vertical online service recommendations are content-based. That is, the cross-online service vertical entities are paired together for recommendation purposes based on the respective content of the entities including any textual descriptions thereof. One possible way to do this is by a measure of textual and/or semantic similarity between textual descriptions of the entities. For example, a particular employment opportunity may be paired with a particular online course based on the textual and/or semantic similarity between a natural language text description of the particular employment opportunity and a natural language text description of the particular online course.

Content-based approaches for cross-online service vertical entity recommendations typically require tagging of entities with text. The text may be a human-authored natural language written description of the entity, for example. Such tagging is error prone, requires domain-specific knowledge, and is costly because of the human labor involved. An online service may attempt to mitigate this by allowing users of the online service to tag entities with text descriptions the users provide themselves. However, user-provided text descriptions are subject to manipulation by users. For example, a user may provide a misleading text description for a particular entity that improperly influences the ranking or relevance of the entity with respect to other entities within the online service. For example, a text description of an online learning course provided by a user may include a mention of particular skills taught that are, in fact, only superficially covered by the course, or not covered at all, with the intent that the online learning course is recommended for popular employment opportunity postings requiring the particular skills.

There is, therefore, a need in the art for improved cross-online service vertical entity recommendations.

The approaches described in this section are approaches that could be pursued, but not necessarily approaches that have been previously conceived or pursued. Therefore, unless otherwise indicated, it should not be assumed that any of the approaches described in this section qualify as prior art merely because of their inclusion in this section.

### SUMMARY OF THE DISCLOSURE

A historical online user behavior-based approach is used to make a recommendation of a cross-online service vertical entity for a primary online service vertical entity with which a user is currently interacting online. The recommendation is made based on the similarity of historical online user behavior between the vertical entities. To do this, historical online user behavior of each of the vertical entities is represented as a respective vector. Each dimension of a vector represents a historical level of interaction between a separate user or a separate group of related users and the vertical entity represented by the vector. A similarity measure is used to measure the similarity between the vectors for the vertical entities. The recommendation of the cross-online service vertical entity is then made for the primary online service vertical entity based on the extent of the similarity between the vectors. The extent of the similarity between the vectors may be measured by the cosine similarity, for example.

The historical online user behavior-based approach improves on content-based approaches for cross-online service vertical entity recommendations by making recommendations based on the similarity of historical online user behavior between the vertical entities. Data that reflects historical online user behavior can be generated and recorded internally by the online service based on observing how users interact online with the entities. The observational nature of the online user behavior allows the online service to have greater control the data generated and recorded relative to user-entered text descriptions, thereby improving the accuracy, integrity, and reliability of the data on which the cross-vertical entity recommendations are based, when compared to content-based approaches, especially those content-based approaches that allow users themselves to tag vertical entities with text descriptions.

While the historical online user behavior-based approach may be used instead of a content-based approach to make a cross-online service vertical entity recommendation, the historical online user behavior-based approach may be used in conjunction with a content-based approach, or another approach. For example, a recommendation of a cross-online service vertical entity can be made for a primary online service vertical entity based on an overall numerical similarity score for the entities that is a linear combination of a weighted numerical content-based similarity measurement for the entities and a weighted numerical historical online user-behavior-based similarity measurement for the entities.

Although specific advantages have been enumerated above, various embodiments of the present invention may include some, none or all of the enumerated advantages. Additionally, other technical advantages may become readily apparent to one of ordinary skill in the art after view of the following figures and description.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart of a method for cross-online service vertical entity recommendations based on similar historical online user behavior between entities, according to some embodiments of the present invention;

FIG. 2 is a wireframe mock-up of a possible graphical user interface concurrently displaying a primary vertical entity an online user is currently interacting with and a recommended cross-vertical entity;

FIG. 3 is a block diagram of a computer system with which some embodiments of the present invention may be implemented.

### DETAILED DESCRIPTION OF EMBODIMENTS

In the following detailed description, embodiments of providing a recommendation of a cross-online service vertical entity for a primary online service vertical entity that a user is currently interacting with online based on the similarity of historical online user behavior between the entities are disclosed. For the purposes of explanation, numerous specific details are set forth in order to provide a thorough understanding of the embodiments. It will be apparent, however, that the embodiments may be practiced without these specific details. In other instances, well-known structures and devices are shown in block diagram form to avoid unnecessarily obscuring the embodiments. Additionally, unless otherwise specifically noted, articles depicted in the drawings are not necessarily drawn to scale.

### Method for Cross-Online Service Vertical Entity Recommendations Based on Similar Historical Online User Behavior Between Vertical Entities

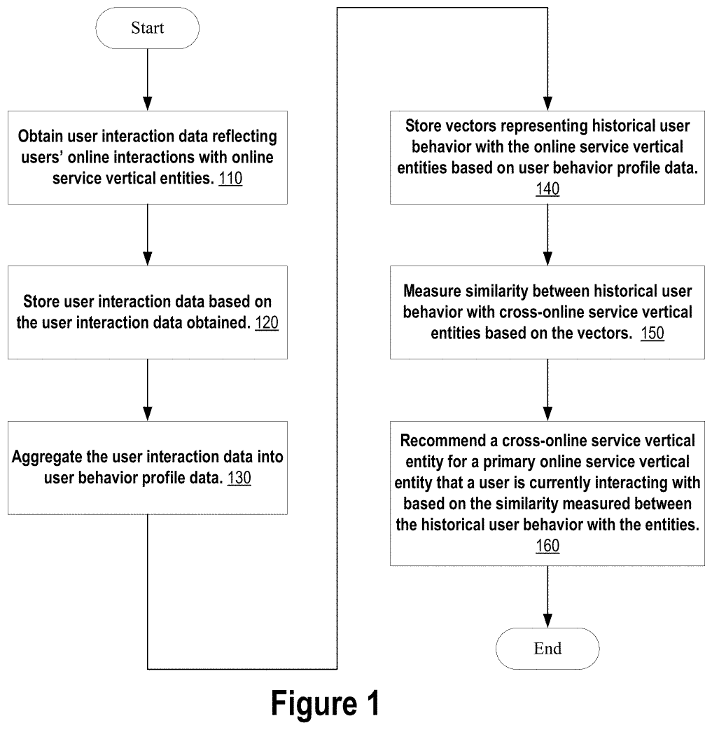

FIG. 1 is a flowchart of a method for cross-online service vertical entity recommendations based on respective historical online user behavior, according to some embodiments of the present invention. The method includes the operations of obtaining 110, storing user interaction data 120, aggregating 130, storing vectors 140, measuring 150, and recommending 160. The obtaining operation 110 includes obtaining user interaction data reflecting users' online interactions with online service vertical entities. The storing user interaction data operation 120 is based on the user interaction data obtained 110. The aggregating operation 130 involves aggregating the user interaction data stored 120 into user behavior data. The storing vectors operation 140 involves storing vectors representing historical user behavior with the online service vertical entities based on the user behavior profile data aggregated 130. The measuring operation 150 involves measuring similarity between historical user behavior between cross-online service vertical entities based on the vectors stored 140. The recommendation operation 160 involves recommending a cross-online service vertical entity for a primary online service vertical entity that a user is currently interacting with based on the measured 150 similarity between the historical online user behavior with the recommended cross-online service vertical entity and the primary online service vertical entity.

Each of these operations 110, 120, 130, 140, 150, and 160 are described in greater detail. First, however, some context in which the method of FIG. 1 may be performed is provided.

### Method Performance Context

An online service provider of an online service may provide different online service verticals. For purposes of this disclosure, the online service can be any service provided by an application or set of applications (typically implemented in software) running online (e.g., on the internet) and making information (e.g., textual information) and media (e.g., images, photos, video and/or audio) available to users of the online service over a computer network (e.g., the internet) via a client application interface (e.g., a web browser application or a mobile application) that the users at their personal computing devices use to request, receive, and consume the information and media obtained (e.g., downloaded) from the online service. The information and media available from an online service may include information that is derived or based on information provided by users to the online service over a computer network via user input directed to the client application interface. For purposes of this disclosure, an online service vertical, then, can be a particular online service where the primary information and media available to users is specific to a particular industry or market or other group of users with specific needs.

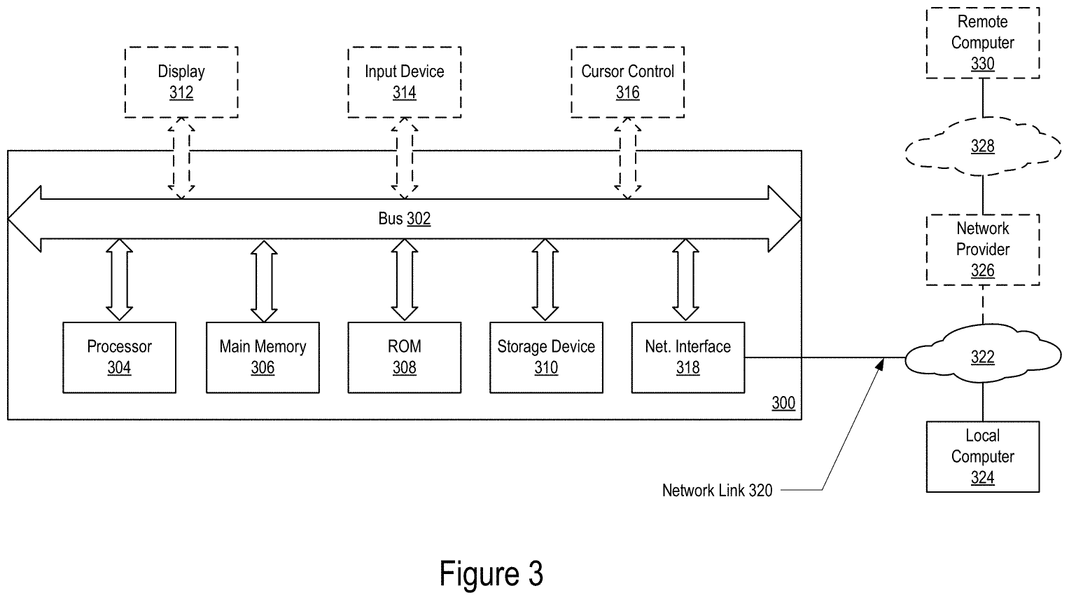

The method of FIG. 1 may be performed by a computing system operated or controlled by an online service provider of an online service that provides at least one online service vertical for which recommendations are made according to the method of FIG. 1. For example, in some embodiments, the online service is a professional networking service and the online service verticals offered by the online service include both (a) employment opportunities for employment seeking users, talent seeking users and talent recruiting users and (b) online learning for student users and course providing users, and the method of FIG. 1 is performed by a computing system operated or controlled by the professional networking service provider to make recommendations of employment opportunities for online learning courses, and vice versa. As an alternative, the method may be performed by a computing system of an online service that provides only one of the online service verticals involved in making recommendations according to the method of FIG. 1. For example, different online service providers may provide separate online services and a data sharing agreement may be established between the providers to enable a computing system operated or controlled by one or both providers to perform the method of FIG. 1. For example, an online service provider of an online learning service vertical may share user interaction data and other information it collects with a different online service provider of an employment opportunities service vertical so that a computing system controlled or operated by the employment opportunities online service provider can make online learning course recommendations for employment opportunities according to the method of FIG. 1. In any case, the computing system that performs the method of FIG. 1 may have one or more processors (e.g., 304 of FIG. 3) and storage media (e.g., 310 of FIG. 3) storing one or more programs having instructions configured to perform the method of FIG. 1. The one or more processors and storage media may be provided by one or more computer systems (e.g., 300 of FIG. 3), such as, for example, by one or more server computers racked and networked in a data center or other computer hosting facility.

An online service vertical can make specific information and media available to users as online service vertical entities. An online service vertical entity, or just vertical entity for the sake of brevity, is a separate instance of the primary information and media made available to users by the service vertical. The instance made available may vary depending on the specific industry or market or other group of users with specific needs that the service vertical addresses. For example, a vertical entity made available by an online learning service vertical may include a particular online learning course, or a particular session or class thereof. As another example, a vertical entity made available by an employment seeking service vertical may include a particular employment opportunity such as a particular job opening. More generally, a vertical entity can be any separately identifiable collection of information and media made available by the service vertical that is associated with a unique identifier that unique identifies the vertical entity among a class or group of vertical entities to which the vertical entity belongs. For example, an online learning service vertical may uniquely identify each course among a set of courses offered by the online learning service vertical (e.g., the set of all courses offered by the learning service vertical, or a subset thereof.) And within each course, the online service vertical may uniquely identify each session or class thereof among all sessions or classes of the course. As another example, an employment opportunity service vertical may uniquely identify each employment opportunity or job opening among a set of employment opportunities or job openings (e.g., the set of all employment opportunities or job openings offered by the service vertical, or a subset thereof).

The data form of the unique identifier of a vertical entity may vary according to the requirements of the particular implementation at hand. For example, a unique integer or string value may be used as the unique identifier. One skilled in the art will appreciate from the foregoing discussion that the term “unique,” when referring to a unique identifier of a vertical entity, is not necessarily an identifier that is globally unique across all time and space (e.g., a GUID), although it can be. Instead, at a minimum, the identifier for a vertical entity is unique at least among of a set of identifiers identifying a set of vertical entities (e.g., a set of online learning courses) to which the vertical entity belongs.

A purpose of performing the method of FIG. 1 is to determine a cross-vertical entity to recommend for a primary vertical entity that a user is currently interacting within online. As mentioned above, a conventional approach to doing this would be to measure the similarity of content between the entities. Although not exclusive of a content-based approach, the present approach eschews content-based similarity for determining related cross-vertical entities for a more unconventional approach based on the similarity of historical online user behavior between cross-vertical entities that may be more accurate, more reliable, and less subject to manipulation than conventional content-based approaches. As an example, according to the historical online user behavior-based approach, a particular online learning course vertical entity may be recommended for a particular employment opportunity vertical entity based on the same users interacting similarly online with the entities. The two entities can be identified as related to each other this way even if their respective content is dissimilar. Thus, the present approach may discover related cross-vertical entities based on the respective historical online user behavior with the entities that would not be discovered by a content based-approach.

### Obtaining and Storing User Interaction Data

Returning again to the top of the method of FIG. 1, user interaction data reflecting users' online interactions with vertical entities is obtained 110 by an online service. For example, for an online interaction between a user and a vertical entity reflected by the user interaction data, the user interaction data obtained may include all of the following information, or a subset, or a superset thereof:
an identifier (e.g., a user identifier or a user account identifier) of the user that conducted the online interaction,
an identifier of the vertical entity that was the subject of the online interaction,
a date/time the user performed the online interaction,
a uniform resource locator (or data thereof) associated with the user interaction,
an identifier of a graphical user interface element that was the subject of the user interaction,
a session identifier that identifies a user session during which the user interaction occurred,
a network address (e.g., an IP address) associated with a network request received by the online service and caused to be sent to the online service by the user interaction, and
user input provided by the user with the user interaction.

A user interaction between a user and a vertical entity can occur in a variety of different ways. For example, a user interaction can occur when a user provides user input to a client interface application at the user's personal electronic device while the client interface application is presenting information and/or media of vertical entity in a user interface of the personal electronic device (e.g., a graphical user interface.) The user may provide the user input using a variety of different user input devices. For example, the user may provide the user input using a keyboard, a pointing device (e.g., a mouse), a touchpad, a touchscreen or other user input device of the user's personal electronic device. The user input itself may take a variety of different forms. For example, the user input may include:
text (e.g., one or more sequences of text characters) entered into a text entry graphical user interface element by the user,
a value associated with an interactive graphical user interface element selected by the user such as, for example, a button, a checkbox, a drop-down list, a hyperlink, a hyperlinked media element (e.g., a hyperlinked image or photo), or
a digital file selected for upload to the online service by the user using a file system file browser graphical user interface control.

The online service may obtain 110 the user interaction data in a variety of different ways. For example, the online service may collect the user interaction data itself by storing the user interaction data in one or more user interaction logs based on network requests received from users' personal computing devices. In addition, or alternatively, the online service may obtain 110 some or all of the user interaction data from another online service such as, for example, online service configured to collect, store and share user interaction data with the online service.

At operation 120, the online service stores 120 the user interaction data obtained 110. The online service may store the obtained user interaction data in storage media (e.g., one or more storage devices (3010 of FIG. 3). The online service may store the obtained user interaction data in a variety of different formats including, for example, in a relational database format or a key-value datastore format. The online service stores the obtained user interaction for aggregation in the aggregating operation 130 described in the next section.

### Aggregating the User Interaction Data into User Behavior Profiles

At operation 130, the user interaction data stored 120 is aggregated 130 into user behavior profile data by vertical entities and by user or by groups of related users. If a group of related users, the users can be related together according to all of the following attributes of the users, or by a subset of these attributes, or a superset thereof:
the users' level of educational attainment (e.g., high school, college, post-college, etc.), geographic location (e.g., user's city, county, region or state of residence or employment),
users' employer,
the type, industry or class of the users' employer, and
the users' organizational level (e.g., manager, director, executive, etc.).

The user behavior profile data may reflect the extent, magnitude and quality of the users' or the groups of related users' historical online interactions with vertical entities along various online interaction metrics. The online interaction metrics may be specific to a type of vertical entity. For example, for an online learning vertical entity, the online interaction metrics of the user behavior profile data aggregated 130 for a particular user and the online learning vertical entity may include all of the following online interaction metrics, or a subset of these metrics, or a superset thereof:
How many times the user has viewed the online course (e.g., a number of web page views of the online course),
Whether the user has enrolled or registered for the online course (e.g., by successfully selecting an “Enroll” or “Register” button for the online course in a graphical user interface),
Whether the user has started the online course (e.g., by downloading or streaming a video of the online course or by providing user input to the online course),
Whether the user has completed the online course,
How much total time the user has spent in the online course as measured, for example, by the sum of all clock time the user spent playing course videos or the sum of all user session lengths during which the user interacted online with course materials (e.g., by playing videos, answering online questions, etc.),
Whether the user has saved, favorited or liked the online course either via the online service or via a third-party online service such as via a third-party social networking service,
Whether the online course appeared in a set of search results presented to the user as relevant to a search query submitted by the user,
Whether the user clicked on a search result for the online course in a set of search results presented to the user as relevant to a search query submitted by the user,
Whether the user has commented on the online course in a comment thread or other online message board, and
Whether the user has shared the online course as a hyperlink to the online course website with one or more other users.

As another example, for an employment opportunity vertical entity, the online interaction metrics of the user behavior profile data aggregated 130 for a particular user and the employment opportunity vertical entity may include all of the following online interaction metrics, or a subset of these metrics, or a superset thereof:
How many times the user has viewed the employment opportunity,
Whether the user has applied for the employment opportunity,
Whether the user has saved, favorited or liked the employment opportunity either via the online service or via a third-party online service such as via a third-party employment opportunity, job hunting, or professional network online service,
Whether the user has commented on the employment opportunity in a comment thread or other online message board,
Whether the user has updated their online professional network member profile to indicate they accepted an offer of employment with respect to the employment opportunity (e.g., by listing the position as a current place of employment),
Whether the employment opportunity appeared in a set of search results presented to the user as relevant to a search query submitted by the user,
Whether the user clicked on a search result for the employment opportunity in a set of search results presented to the user as relevant to a search query submitted by the user,
Whether the user accepted an online invitation to the employment opportunity from an employment recruiter or other recruiting professional, and
Whether the user has shared the employment opportunity as a hyperlink to the employment opportunity web page with one or more other users.

The user interaction data aggregated 130 into user profile data for a user and a vertical entity may correspond to a particular period of time. For example, user profile data for a particular user and a particular vertical entity may be aggregated 130 from user interaction data reflecting online user interactions by that particular user with the particular vertical entity in a past period of time such as the past 30 days, the past three months, the past quarter, the past year, etc.

### Vector Model

At operation 140, the historical online user behavior profile data aggregated 130 from the stored user interaction data 120 is represented as a stored 140 set of vectors. The representation may by an interaction-level matrix that represents the extent, magnitude and quality of user interaction with vertical entities. Specifically, the representation may be a vertical entity-user behavior interaction-level matrix where each row (or column) represents a user or a group of related users and each column (or row) represents a vertical entity.

For example, Table 1 below shows a small selection from a vertical entity-user behavior interaction-level matrix showing the extent of user interaction by four users with four vertical entities.

| | Alice | Bob | Charlie | Debbie |
|---|---|---|---|---|
| Employment Opportunity A | 0.10 | 0.10 | 0.80 | 0.15 |
| Employment Opportunity B | 0.20 | 0.20 | 0.12 | 0.36 |
| Online Learning Course C | 0.37 | 0.58 | 0.10 | 0.50 |
| Online Learning Course D | 0.50 | 0.12 | 0 | 0 |

Each cell in the above-matrix is a numerical value representing the extent of user interaction by a user (defined by the column) with a vertical entity (defined by the row). The numerical cell values in the example matrix above are selected for purposes of illustration and may differ in a practical implementation.

For example, each cell value may be a numerical value between [0, 1] or [−1, 1] that is a linear combination of multiple weighted normalized numerical values where each such normalized weighted numerical value is derived from an online interaction metric of the user behavior profile data for the corresponding user (or group of related users) and the corresponding vertical entity.

For example, the cell value 0.12 for Bob and Online Learning Course D may be a weighted linear combination such as [(W₁ multiplied by X₁)+(W₂ multiplied by X₂)] where X₁ is a normalized numerical value representing the amount of time user Bob spent in Online Learning Course D according to the corresponding online user behavior profile data aggregated 130 for user Bob and Online Learning Course D and where X₂ is a normalized numerical value representing the number of times Bob viewed Online Learning Course D according to the corresponding online user behavior profile data. The same linear combination formula may be used to produce the other cell values for Online Learning Course C and Online Learning Course D. For example, the cell value of zero for user Charlie and Online Learning Course D means that Charlie has not spent any time in or ever viewed Online Learning Course D according to the online user behavior profile data aggregated 130 for Charlie and Online Learning Course D.

As another example, the cell value 0.36 for Debbie and Employment Opportunity B may also be a weighted linear combination such as [(W₃ multiplied by X₃)+(W₄ multiplied by X₄)+(W₅ multiplied by X₅)] where X₃ is a normalized numerical value representing the number of times Debbie viewed Employment Opportunity B according to the online user behavior profile data aggregated 130 for Debbie and Employment Opportunity B, X₄ is a normalized numerical value representing whether Debbie favorited, saved or liked Employment Opportunity B according to the corresponding online user behavior profile data, and X₅ is a normalized numerical value representing whether Debbie applied for Employment Opportunity B according to the corresponding online user behavior profile data.

Online interaction metrics may be normalized for use in the weighted linear combination by rescaling the metrics into a predefined numerical range such the range zero to one [0, 1] or the range negative one to positive one [−1, 1]. In addition, online interaction metrics may be normalized for use in the linear combination by standardizing the metrics by shifting the distribution of the metrics to have a mean of zero and a standard deviation of one. The standardized metrics may then be rescaled and the rescaled values used in the linear combination. For example, the normalized numerical values X₁ through X₅ used in the weighted linear combinations discussed above may be standardized and rescaled online interaction metrics of the aggregated 130 user behavior profile data.

If a column represents a group of related users instead of just a single user, then a cell value may represent an aggregation of interaction metrics for users in the group of related users. For example, if the column for Bob was instead a column for a particular group of related users, then X₁ in the weighted linear combination above may be a normalized numerical value representing the total time or per-user average/mean/median amount of time users in the particular group of related users spent in a corresponding online learning course (e.g., Online Learning Course D). Similarly, X₂ in the weighted linear combination above may be a normalized numerical value representing a total sum or per-user average/mean/median number of times users in the particular group of related users viewed the online learning course.

The weights used in the linear combination may be predefined (e.g., determined empirically) or may be learned based on click-through data available for cross-vertical recommendations according to a supervised machine learning process. For example, whether users click-through cross-vertical entity recommendations may be recorded. For example, user click-through data for recommended vertical entities may be used indication as to the relevance of the recommendations. For example, if a cross-vertical entity recommendation is presented to a user on a web page that also presents a primary vertical entity that the user is currently interacting with and the user clicks on or otherwise selects the cross-vertical entity recommendation presented, the click or selection can be taken as an indication that the particular cross-vertical entity recommendation was “relevant.” On the other hand, if a cross-vertical entity is recommended to the user and the user does not click on or otherwise select the recommendation, the absence of a click or selection may be taken as an indication that the recommendation was “not relevant” or at best “neutral.”

A training set for machine learning may be generated by labeling cross-vertical entity recommendations with a recommendation quality label (e.g., “relevant”, “not relevant”, “neutral”.) The labels may then be used as part of a supervised machine learning process to establish a ground truth. The supervised machine learning process may then learn a set of candidate weights for the weighted linear combination that minimizes a cost function relative to the ground truth.

As mentioned, a cell value of the vertical entity-user behavior interaction-level matrix may represent a weighted linear combination of online interaction metrics for a particular user or (a particular group of related users) and a vertical entity. Depending on the particular users' or group of users' online behavior, their interaction metrics can be skewed and less discriminative. For example, a favorite, like, or save by a user for a particular online course where the user favorites, likes or saves many online courses is less discriminative of online user behavior with respect to the particular online course than a favorite, like or save of the particular online course by another user that has favorited, saved or liked only a few online courses. As such, a normalized interaction metric may be weighted for discriminative value in addition to the weight applied to the metric in the weighted linear combination.

One discriminative value weighting that may be used is TF-IDF, except applied to user behavior with vertical entities instead of to co-occurrence of words in documents as is conventionally done. For example, consider a particular user that favorites, like or saves a particular vertical entity. The term frequency TF for the particular user and the particular vertical entity in the TF-IDF model may be one (instead of zero) to represent that the particular user favorited, liked or saved the particular vertical entity. The inverse document frequency IDF in the TF-IDF model then may be log(N/dfᵢ) where N is a total number of vertical entities and dfᵢ is the number of vertical entities in the total number of vertical entities N that the particular user also favorited, liked or saved. The total number of vertical entities N may be all vertical entities available from the online service, or a selected subset thereof according to the requirements of the particular implementation at hand. The resulting TF-IDF value may then be normalized as described above and the resulting normalized value used in a weighted linear combination that produces the cell value for the matrix. By using a discriminative value weighting for online interaction metrics such as, for example, TF-IDF, online interactions by users with vertical entities where the interactions are relatively rare overall are preferred.

### Measuring Similarity

To measure 150 the similarity between historical user behavior with cross-vertical entities, a vector similarity measure may be used. For example, an inner dot product measure may be used such as:

$$\vec{v} \cdot \vec{w} = {\sum }_{i = 1}^{N} {v}_{i} {w}_{i}$$

Here, \vec{v} and \vec{w} represent vectors for the cross-vertical entities from the vertical entity-user behavior matrix. For example, for the example matrix above, vectors for the vertical entities correspond to the rows of the matrix. For example, the vector for Employment Opportunity B is <0.20, 0.20, 0.12, 0.36> and the vector for Online Course D is <0.50, 0.12, 0, 0>.

The inner dot product of two such vectors may be computed to measure the similarity between the historical online user behavior with the cross-vertical entities. For example, inner dot product similarity between the historical online user behavior with Employment Opportunity B and Online Course D may be computed as:

(0.20*0.50)+(0.20*0.12)+0+0=0.124

The inner dot product functions as a similarity metric because it will tend to be high just when the two vectors have large values in the same dimensions. Alternatively, vectors that zeros in different dimensions will have a dot product of 0, representing their strong dissimilarity.

The above dot-product favors long vectors. In other words, the dot product is higher if a vector is longer, with higher values in each dimension. Vertical entities with more user interaction tend to have longer vectors, since the user interaction metrics for these vertical entities tend to have higher values. The above dot-product thus will be higher for vertical entities with more user interaction.

A similarity metric that measures how similar the user behavior between entities is regardless of frequency of user interaction can be used instead of the above dot-product. In particular, a normalized dot product may be used such as the following cosine similarity measure may be used:

$$\frac{{\sum }_{i = 1}^{N} {v}_{i} {w}_{i}}{\sqrt{{\sum }_{i = 1}^{N} {v}_{i}^{2} \sqrt{{\sum }_{i = 1}^{N} {w}_{i}^{2}}}}$$

Returning to the example, the cosine similarity between inner the historical online user behavior with Employment Opportunity B and Online Course D may be computed as:

$$\frac{( 0.20 * 0.50 ) + ( 0.20 * 0.12 ) + 0 + 0}{\sqrt{{0.20}^{2} + {0.20}^{2} + {0.12}^{2} + {0.36}^{2}} \sqrt{{0.50}^{2} + {0.12}^{2} + {0}^{2} + {0}^{2}}} = \frac{0.124}{\sqrt{0.224} \sqrt{0.2644}} \approx 0.51$$

Other normalized similarity measures may be used instead such as, for example, the Jaccard similarity and the Dice similarity. The Jaccard similarity can be measured as:

$$\frac{{\sum }_{i = 1}^{N} min ( {v}_{i} , {w}_{i} )}{{\sum }_{i = 1}^{N} max ( {v}_{i} , {w}_{i} )}$$

The Dice similarity can be measured as:

$$\frac{2 \times {\sum }_{i = 1}^{N} min ( {v}_{i} , {w}_{i} )}{{\sum }_{i = 1}^{N} ( {v}_{i} + {w}_{i} )}$$

### Making a Recommendation

At operation 160, a recommendation of a cross-online service vertical entity is made for a primary online service vertical entity that a user is currently interacting with online. The recommendation is made based on the similarity measurement between the vectors from the matrix representing the two entities. For example, given a matrix of vertical entities, a similarity measurement may be computed between every unique pair of cross-vertical entities. For example, returning to the example matrix above, four similarity measurements may be made: (1) between the vectors for Employment Opportunity A and Online Course C, (2) between the vectors for Employment Opportunity A and Online Course D, (3) between Employment Opportunity B and Online Course C, and (4) between Employment Opportunity B and Online Course D.

When one of the vertical entities is presented as a primary vertical entity such as by a request from the user for the vertical entity, the similarity measurement(s) computed 140 between the primary vertical entity and one or more cross-vertical entities may be used to select one or more of the cross-vertical entities to recommend for the primary vertical entity. One cross-vertical entity may be recommended for a primary vertical entity over another cross-vertical entity based on their respective similarity measurements with respect to the primary vertical entity. For example, assume the cosine similarity between the vectors of the example matrix for Employment Opportunity B and Online Course D is approximately 0.51 and the cosine similarity between the vectors of the example matrix for Employment Opportunity A and Online Course D is approximately 0.15, then when Online Course D is presented as a primary vertical entity, Employment Opportunity B may be recommended as a cross-vertical entity for Online Course D based on Employment Opportunity B having greater user behavior similarity with Online Course D than Employment Opportunity A according to their respective similarity measurements. In addition, or alternatively, a cross-vertical entity may be selected as a recommendation for a primary vertical entity based on the similarity measurement for the entities meeting or exceeding a threshold.

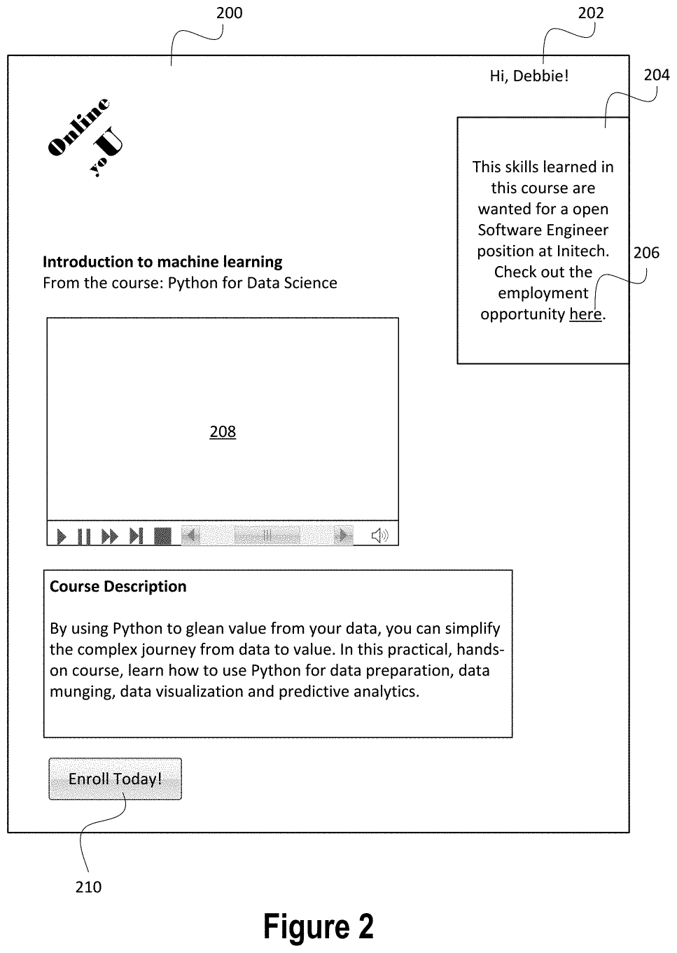

FIG. 2 is a wire frame mock-up of a possible graphical user interface 200 that concurrently displays both a primary vertical entity and a recommended cross-vertical entity selected according to the method of FIG. 1. The GUI 200 may be presented in a web browser window or a mobile application user interface, for example. In this example, the primary vertical entity is an online learning course and the recommended cross-vertical entity is an employment opportunity. The GUI 200 indicates the name 202 of the user “Debbie” that is currently interacting with the primary vertical entity. The recommendation 204 of the cross-vertical entity includes a hyperlink 206 by which the user can navigate to a web page for the recommended employment opportunity. The GUI 200 includes other user interface elements pertaining to the primary vertical entity such as a video playback area 208 for playing a course video and a button 210 that the user can select to enroll in the course.

### Hardware Overview

FIG. 3 is a block diagram that illustrates a computer system 300 with which some embodiments of the present invention may be implemented. Computer system 300 includes a bus 302 or other communication mechanism for communicating information, and a hardware processor 304 coupled with bus 302 for processing information. Hardware processor 304 may be, for example, a general-purpose microprocessor, a central processing unit (CPU) or a core thereof, a graphics processing unit (GPU), or a system on a chip (SoC).

Computer system 300 also includes a main memory 306, typically implemented by one or more volatile memory devices, coupled to bus 302 for storing information and instructions to be executed by processor 304. Main memory 306 also may be used for storing temporary variables or other intermediate information during execution of instructions by processor 304. Computer system 300 may also include a read-only memory (ROM) 308 or other static storage device coupled to bus 302 for storing static information and instructions for processor 304. A storage device 310, typically implemented by one or more non-volatile memory devices, is provided and coupled to bus 302 for storing information and instructions.

Computer system 300 may be coupled via bus 302 to a display 312, such as a liquid crystal display (LCD), a light emitting diode (LED) display, or a cathode ray tube (CRT), for displaying information to a computer user. Display 312 may be combined with a touch sensitive surface to form a touch screen display. The touch sensitive surface is an input device for communicating information including direction information and command selections to processor 304 and for controlling cursor movement on display 312 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

An input device 314, including alphanumeric and other keys, may be coupled to bus 302 for communicating information and command selections to processor 304.

Another type of user input device may be cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Instructions, when stored in non-transitory storage media accessible to processor 304, such as, for example, main memory 306 or storage device 310, render computer system 300 into a special-purpose machine that is customized to perform the operations specified in the instructions. Alternatively, customized hard-wired logic, one or more ASICs or FPGAs, firmware and/or hardware logic which in combination with the computer system causes or programs computer system 300 to be a special-purpose machine.

A computer-implemented process may be performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage device 310) and/or volatile media (e.g., main memory 306). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 302. Transmission media can also take the form of acoustic or light waves, such as those generated during radio-wave and infra-red data communications.

Computer system 300 also includes a network interface 318 coupled to bus 302. Network interface 318 provides a two-way data communication coupling to a wired or wireless network link 320 that is connected to a local, cellular or mobile network 322. For example, communication interface 318 may be IEEE 802.3 wired “ethernet” card, an IEEE 802.11 wireless local area network (WLAN) card, a IEEE 802.15 wireless personal area network (e.g., Bluetooth) card or a cellular network (e.g., GSM, LTE, etc.) card to provide a data communication connection to a compatible wired or wireless network. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through network 322 to a local computer system 324 that is also connected to network 322 or to data communication equipment operated by a network access provider 326 such as, for example, an internet service provider or a cellular network provider. Network access provider 326 in turn provides data communication connectivity to another data communications network 328 (e.g., the internet). Networks 322 and 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the networks 322 and 328, network link 320 and communication interface 318. In the internet example, a remote computer system 330 might transmit a requested code for an application program through network 328, network 322 and communication interface 318. The received code may be executed by processor 304 as it is received, and/or stored in storage device 310, or other non-volatile storage for later execution.

### Extensions and Alternatives

In the foregoing specification, the embodiments have been described with reference to numerous specific details that may vary from implementation to implementation. The specification and drawings are, accordingly, to be regarded in an illustrative rather than a restrictive sense.

What is claimed is:

1. A method comprising:
storing a matrix in storage media, each cell of the matrix having a numerical value representing a magnitude of historical user interaction with a corresponding online service vertical entity and a corresponding user;
measuring a similarity between a first vector of numerical values from the matrix for a first online service vertical entity and a second vector of numerical values from the matrix for a second online service vertical entity;
wherein the first online service vertical entity belongs to a first online service vertical;
wherein the second online service vertical entity belongs to a second online service vertical that is not the first online service vertical;
selecting the first online service vertical entity as a recommendation for the second online service vertical entity based on the similarity measured between the first vector of numerical values and the second vector of numerical values;
causing a graphical user interface to be displayed to a user of an online service where the second online service vertical is presented as a primary online service vertical entity concurrently with a presentation of the first online service vertical entity as a recommendation to the user; and
wherein the method is performed by a computing system having one or more processors and storage media storing one or more programs, the one or more programs including instructions configured to perform the method.

2. The method of claim 1, wherein the similarity is measured as a cosine similarity between the first vector of numerical values and the second vector of numerical values.

3. The method of claim 1, wherein the first online service vertical entity is an online learning course and the second online service vertical entity is an employment opportunity.

4. The method of claim 1, wherein the first online service vertical entity is an employment opportunity and the second online service vertical entity is an online learning course.

5. The method of claim 1, wherein a non-zero cell value of the matrix is computed based on a weighted linear combination of a plurality of user interaction metrics.

6. The method of claim 5, wherein at least one of the plurality of user interaction metrics is normalized for discriminative value according to a term frequency-inverse document frequency model.

7. The method of claim 5, wherein each user interaction metric of the plurality of user interaction metrics reflects a magnitude of a different type of user interaction by a corresponding user with a corresponding vertical entity.

8. One or more non-transitory computer-readable media storing one or more programs having instructions for execution by one or more processors and configured for:
storing a matrix in storage media, each cell of the matrix having a numerical value representing a magnitude of historical user interaction with a corresponding online service vertical entity and a corresponding user;
measuring a similarity between a first vector of numerical values from the matrix for a first online service vertical entity and a second vector of numerical values from the matrix for a second online service vertical entity;
wherein the first online service vertical entity belongs to a first online service vertical;
wherein the second online service vertical entity belongs to a second online service vertical that is not the first online service vertical;
selecting the first online service vertical entity as a recommendation for the second online service vertical entity based on the similarity measured between the first vector of numerical values and the second vector of numerical values;
causing a graphical user interface to be displayed to a user of an online service where the second online service vertical is presented as a primary online service vertical entity concurrently with a presentation of the first online service vertical entity as a recommendation to the user; and
wherein the method is performed by a computing system having one or more processors and storage media storing one or more programs, the one or more programs including instructions configured to perform the method.

9. The one or more non-transitory computer-readable media of claim 8, wherein the similarity is measured as a cosine similarity between the first vector of numerical values and the second vector of numerical values.

10. The one or more non-transitory computer-readable media of claim 8, wherein the first online service vertical entity is an online learning course and the second online service vertical entity is an employment opportunity.

11. The one or more non-transitory computer-readable media of claim 8, wherein the first online service vertical entity is an employment opportunity and the second online service vertical entity is an online learning course.

12. The one or more non-transitory computer-readable media of claim 8, wherein a non-zero cell value of the matrix is computed based on a weighted linear combination of a plurality of user interaction metrics.

13. The one or more non-transitory computer-readable media of claim 12, wherein at least one of the plurality of user interface metrics is normalized for discriminative value according to a term frequency-inverse document frequency model.

14. The one or more non-transitory computer-readable media of claim 12, wherein each user interaction metric of the plurality of user interaction metrics reflects a magnitude of a different type of user interaction by a corresponding user with a corresponding vertical entity.

15. A computing system comprising:
one or more processors;
storage media; and
one or more programs stored in the storage media and having instructions for execution by the one or processors and configured for:
storing a matrix in storage media, each cell of the matrix having a numerical value representing a magnitude of historical user interaction with a corresponding online service vertical entity and a corresponding user;
measuring a similarity between a first vector of numerical values from the matrix for a first online service vertical entity and a second vector of numerical values from the matrix for a second online service vertical entity;
wherein the first online service vertical entity belongs to a first online service vertical;
wherein the second online service vertical entity belongs to a second online service vertical that is not the first online service vertical;
selecting the first online service vertical entity as a recommendation for the second online service vertical entity based on the similarity measured between the first vector of numerical values and the second vector of numerical values;
causing a graphical user interface to be displayed to a user of an online service where the second online service vertical is presented as a primary online service vertical entity concurrently with a presentation of the first online service vertical entity as a recommendation to the user; and
wherein the method is performed by a computing system having one or more processors and storage media storing one or more programs, the one or more programs including instructions configured to perform the method.

16. The computing system of claim 15, wherein the similarity is measured as a cosine similarity between the first vector of numerical values and the second vector of numerical values.

17. The computing system of claim 15, wherein the first online service vertical entity is an online learning course and the second online service vertical entity is an employment opportunity.

18. The computing system of claim 15, wherein the first online service vertical entity is an employment opportunity and the second online service vertical entity is an online learning course.

19. The computing system of claim 18, wherein a non-zero cell value of the matrix is computed based on a weighted linear combination of a plurality of user interaction metrics.

20. The computing system of claim 19, wherein at least one of the plurality of user interaction metrics is normalized for discriminative value according to a term frequency-inverse document frequency model.
